(19) United States
(12) Patent Application Publication
(10) Pub. No.: US 2022/0229479 A1
(43) Pub. Date: Jul. 21, 2022

(54) POWER SUPPLY UNIT (PSU)-BASED POWER SUPPLY SYSTEM

(71) Applicant: INSPUR SUZHOU INTELLIGENT TECHNOLOGY CO., LTD., Suzhou (CN)

(72) Inventor: Siheng LUO, Suzhou (CN)

(21) Appl. No.: 17/595,977

(22) PCT Filed: Sep. 27, 2019
(86) PCT No.: PCT/CN2019/108424

§ 371 Date: Nov. 30, 2021

(30) Foreign Application Priority Data
Sep. 12, 2019 (CN) 201910866511.4

(51) Int. Cl. G06F 1/26; H02H 3/08

(52) U.S. Cl. CPC G06F 1/26; H02H 3/08

(57) ABSTRACT

A power supply unit (PSU)-based power supply system. A first output port of the PSU is connected to a main control component of a main board by using a voltage converter, and is used to supply power to the main control component in a system standby state. A second output port of the PSU may be connected to a load variable component of the main board; or the first output port and the second output port of the PSU may be connected to the load variable component by means of a power switching apparatus, and an enabling end of the PSU is grounded, so that both the first output port and the second output port have a voltage output when the PSU is inserted into the main board. A current value output by the second output port is relatively large load variable, which meets a power supply requirement of the load variable component. The second output port of the PSU is connected to each power-on running component of the main board by means of a switch component, and the switch component is in an off state in the system standby state. After the system is powered on, the switch component is in an on state, so that each power-on running component does not have extra power consumption when the system is in standby mode.

### CROSS-REFERENCE TO RELATED APPLICATIONS

This application is a 371 of International Patent Application Number PCT/CN2019/108424, filed on Sep. 27, 2019, which claims the benefit and priority of Chinese Patent Application Number 201910866511.4, filed on Sep. 12, 2019 with China National Intellectual Property Administration, the disclosures of which are incorporated herein by reference in their entireties.

### TECHNICAL FIELD

The present disclosure relates to the technical field of power supply of servers, in particular to a power supply unit (PSU)-based power supply system.

### BACKGROUND

With the development of cloud computing application, a general server structure is formed in a manner that a 2 U machine case is mainly arranged on a rack of a machine room, wherein U is a unit representing external dimensions of the server, which is an abbreviation of ‘unit’. In order to enhance the functional expansibility of the server in a 2 U space, a high-speed peripheral component interconnect express (PCIE) adapter card is usually used to transfer a plurality of externally inserted sub-cards with different functions and performances through a main board PCIE, such as a Gigabit network card, 10 Gigabit network card, an SAS card and a redundant array of independent disk (RAID) card. By cooperation of different externally inserted sub-cards, a 2 U universal server can meet the application requirements of different users.

In a general 2 U universal server, a server system is supplied with power by a 1+1 redundant power supply unit (PSU) which is directly plugged into a main board; FIG. 1 is a schematic diagram of a power supply structure of a conventional 2 U universal server system; and the PSU is directly plugged into the main board to realize that a system of the main board is supplied with power by P12V_STBY and P12V_PSU. In FIG. 1, VRn (n=1-7) represents a direct current-direct current converter (DC/DC), by which a voltage provided by a P12V AUX and the P12V_PSU can be converted into a voltage required by a chip. E-FUSEm (m=0,1) represents a power supply overcurrent protection switch. A switch circuit is configured to realize switch between the P12V_STBY and the P12V_PSU. Before the server system is started, the P12V_STBY provides a power supply to ensure normal operation of basic components such as a baseboard management controller (BMC) chip, a platform controller hub (PCH), a complex programmable logic device (CPLD), an Other IC and an externally inserted sub-card (PCIE CARD) in the server. After the server system is started, the switch circuit switches the P12V_PSU to provide a power supply.

In the power industry, the P12V_STBY on a single PSU has a rated current of 3 A, which is applied to a 2 U general server system to provide standby power supply for the server system. However, with increment of the quantity of externally inserted sub-cards, current demand involved in the externally inserted sub-cards is increased as well. When the externally inserted sub-cards matched with the server system are increased to a certain quantity or have higher power consumption, a current required for power supply will exceed 3 A, which may cause insufficient standby power supply for the PSU.

It can be seen that insufficient standby power supply for the PSU is the problem to be solved by those skilled in the art.

### SUMMARY

An embodiment of the present disclosure aims to provide a power supply unit (PSU)-based power supply system to solve the problem of insufficient standby power supply for a PSU.

To solve the above technical problem, the embodiment of the present disclosure provides a PSU-based power supply system, which includes:

a first output port of a PSU is connected with a main control component of a main board through a voltage converter in order to supply power to the main control component in a system standby state;

a second output port of the PSU is connected with a load variable component of the main board, and an enabling end of the PSU is grounded to supply power to the load variable component of the main board in a system standby state;

the second output port of the PSU is connected with each power-on running component of the main board through a switch component; the switch component is in an off state in a system standby state; after the system is started, the switch component is in an on state,

wherein the first output port outputs a smaller current than the second output port.

Optionally, the main control components include a baseboard management controller (BMC) chip, a platform controller hub (PCH) chip, a complex programmable logic device (CPLD) chip and a functional logic chip; the load variable component is an externally inserted sub-card;

the BMC chip is connected with the first output port of the PSU through a first voltage converter;

the PCH chip is connected with the first output port of the PSU through a second voltage converter;

the CPLD chip is connected with the first output port of the PSU through a third voltage converter;

the functional logic chip is connected with the first output port of the PSU through a fourth voltage converter; and

the externally inserted sub-card is connected with the second output port of the PSU.

Optionally, the PSU-based power supply system further includes an overcurrent protection switch;

an input end of the overcurrent protection switch is connected with the first output port of the PSU; and an output end of the overcurrent protection switch is connected with input ends of the first voltage converter, the second voltage converter, the third voltage converter and the fourth voltage converter, respectively.

Optionally, the main control component is a BMC chip; the load variable component includes a PCH chip, a CPLD chip, a functional logic chip and an externally inserted sub-card;

the BMC chip is connected with the first output port of the PSU through the first voltage converter;

the PCH chip is connected with the second output port of the PSU through the second voltage converter;

the CPLD chip is connected with the second output port of the PSU through the third voltage converter;

the functional logic chip is connected with the second output port of the PSU through the fourth voltage converter; and

the externally inserted sub-card is connected with the second output port of the PSU.

Optionally, the PSU-based power supply system further includes an overcurrent protection switch;

an input end of the overcurrent protection switch is connected with the second output port of the PSU; and an output end of the overcurrent protection switch is connected with input ends of the second voltage converter, the third voltage converter and the fourth voltage converter and the externally inserted sub-card, respectively.

Optionally, the CPLD chip is connected with the switch component and configured to input a start signal to the switch component after the system is started, so as to control on and off of the switch component.

Optionally, when the main control component includes the BMC chip, the PCH chip, the CPLD chip and the functional logic chip, the overcurrent protection switch has a current limit value which is 1.3 times the total load current value of the main control component; and

when the load variable component includes the PCH chip, the CPLD chip, the functional logic chip and the externally inserted sub-card, the overcurrent protection switch has a current limit value which is 1.3 times the total load current value of the load variable component.

An embodiment of the present disclosure further provides a PSU-based power supply system, which includes:

a first output port of a PSU is connected with main control components of a main board through voltage converters in order to supply power to the main control components in a system standby state;

the first output port and a second output port of the PSU are connected with a load variable component of the main board through a power switching apparatus; in addition, an enabling end of the PSU is grounded so that when the load variable component has a current smaller than a threshold value, the power switching apparatus is switched to supply power from the first output port of the PSU to the load variable component; when the load variable component has a current larger than or equal to the threshold value, the power switching apparatus is switched to supply power from the second output port of the PSU to the load variable component;

the second output port of the PSU is connected with each power-on running component of the main board through a switch component; the switch component is in an off state in a system standby state; after the system is started, the switch component is in an on state,

wherein the first output port outputs a smaller current than the second output port.

Optionally, the power switching apparatus includes a power switch component and a current detection component, where the current detection component includes a sampling resistor and a switch control chip;

an input end of the power switch component is respectively connected with the first output port and the second output port of the PSU;

an output end of the power switch component is connected with the load variable component through the sampling resistor; and

a first input end of the switch control chip is connected with one end of the sampling resistor; a second input end of the switch control chip is connected with the other end of the sampling resistor; an output end of the switch control chip is connected with the power switch component in order to input a corresponding level signal to the power switch component according to a relationship between a current value and a threshold value of the load variable component, thereby controlling the power switch component to switch an output port for supplying power to the load variable component.

Optionally, the power switch component includes a first p-channel metal oxide semiconductor (PMOS) transistor, a second PMOS transistor, a first phase inverter and a second phase inverter;

a first port of the first PMOS transistor is connected with the second output port of the PSU; a second port of the first PMOS transistor is connected with the load variable component through the sampling resistor; a third port of the first PMOS transistor is connected with an output end of the first phase inverter, and the output end of the first phase inverter is connected with an input end of the second phase inverter;

a first port of the second PMOS transistor is connected with the first output port of the PSU; the second port of the first PMOS transistor is connected with the load variable component through the sampling resistor; a third port of the first PMOS transistor is connected with an output end of the second phase inverter; and

an output end of the switch control chip is connected with an input end of the first phase inverter and configured to input a low level to the first phase inverter when the load variable component has a current smaller than the threshold value,

and input a high level to the first phase inverter when the load variable component has a current larger than or equal to the threshold value.

Optionally, the main control components include a BMC chip, a PCH chip, a CPLD chip and a functional logic chip; the load variable component is an externally inserted sub-card;

the BMC chip is connected with the first output port of the PSU through the first voltage converter;

the PCH chip is connected with the first output port of the PSU through the second voltage converter;

the CPLD chip is connected with the first output port of the PSU through the third voltage converter; and

the functional logic chip is connected with the first output port of the PSU through the fourth voltage converter.

Optionally, the PSU-based power supply system further includes an overcurrent protection switch;

an input end of the overcurrent protection switch is connected with the first output port of the PSU; and an output end of the overcurrent protection switch is connected with input ends of the first voltage converter, the second voltage converter, the third voltage converter and the fourth voltage converter, respectively.

Optionally, the main control component is a BMC chip; the load variable component includes a PCH chip, a CPLD chip, a functional logic chip and an externally inserted sub-card;

the BMC chip is connected with the first output port of the PSU through the first voltage converter;

the PCH chip is connected with the second output port of the PSU through the second voltage converter; t

the CPLD chip is connected with the second output port of the PSU through the third voltage converter;

the functional logic chip is connected with the second output port of the PSU through the fourth voltage converter: and

the externally inserted sub-card is connected with the second output port of the PSU through the power switching apparatus.

Optionally, the PSU-based power supply system further includes an overcurrent protection switch;

an input end of the overcurrent protection switch is connected with the second output port of the PSU; and an output end of the overcurrent protection switch is connected with input ends of the second voltage converter, the third voltage converter, the fourth voltage converter, respectively.

Optionally, the CPLD chip is connected with the switch component and configured to input a start signal to the switch component after the system is started, so as to control on and off of the switch component.

Optionally, when the main control component includes the BMC chip, the PCH chip, the CPLD chip and the functional logic chip, the overcurrent protection switch has a current limit value which is 1.3 times the total load current value of the main control component; and

when the load variable component includes the PCH chip, the CPLD chip, the functional logic chip and the externally inserted sub-card, the overcurrent protection switch has a current limit value which is 1.3 times the total load current value of the PCH chip, the CPLD chip and the functional logic chip.

It can be seen from the above technical solution that the PSU in the PSU-based power supply system includes two output ports, wherein the first output port outputs a smaller current than the second output port. The first output port of the PSU is connected with the main control components of the main board through the voltage converters in order to supply power to the main control components in a system standby state. Even if the second output port has a fault, the main control components on the main board can still normally monitor a working state of the PSU. The second output port of the PSU may be connected with the load variable component of the main board, or the first output port and the second output port of the PSU are connected with the load variable component of the main board by means of the power switching apparatus; and the enabling end of the PSU is grounded, so that both the first output port and the second output port have a voltage output when the PSU is inserted into the main board. In addition, the second output port outputs a larger current to meet the power supply requirements of the load variable component, which effectively prevents occurrence of insufficient power supply of the first output port when the load variable component has relatively high power consumption. The second output port of the PSU is connected with each power-on running component of the main board by means of the switch component; the switch component is in an off state in a system standby state; after the system is powered on, the switch component is in an on state; and the PSU supplies power to each power-on running component through the second output port. By controlling on and off of the switch component, all power-on running components are ensured not to consume extra electric energy in a system standby state.

### BRIEF DESCRIPTION OF THE DRAWINGS

To describe the embodiments of the present disclosure more clearly, the accompanying drawings to be used in the embodiments will be briefly described below. Apparently, the accompanying drawings described below are merely some embodiments of the present disclosure. A person of ordinary skill in the art may further obtain other accompanying drawings based on these accompanying drawings without creative efforts.

FIG. 1 is a schematic diagram of a power supply structure of a conventional 2 U universal server system;

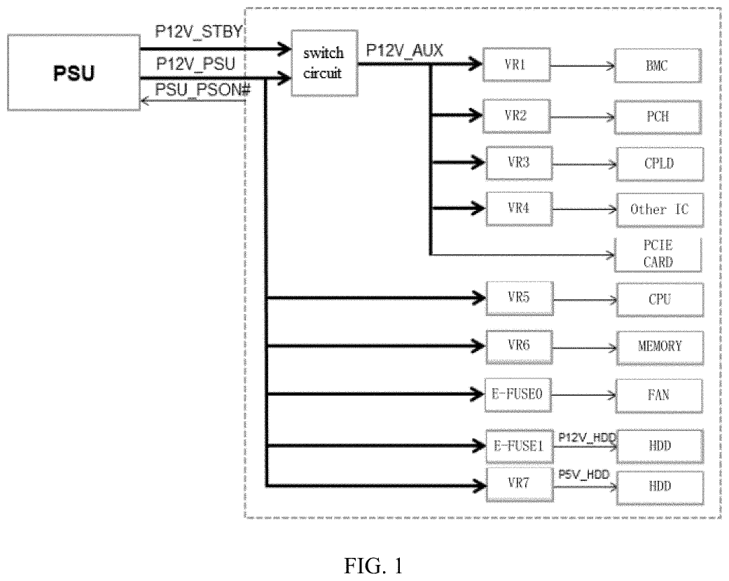

FIG. 2 is a structural schematic diagram of a PSU-based power supply system in accordance with an embodiment of the present disclosure;

FIG. 3 is a structural schematic diagram of a power supply system provided with an overcurrent protection switch based on FIG. 2 in accordance with an embodiment of the present disclosure;

FIG. 4 is a structural schematic diagram of a PSU-based power supply system capable of dynamically adjusting a power supply mode in accordance with an embodiment of the present disclosure;

FIG. 5 is a structural schematic diagram of a power supply system provided with an overcurrent protection switch based on FIG. 4 in accordance with an embodiment of the present disclosure; and

FIG. 6 is a structural schematic diagram of a power switching apparatus in accordance with an embodiment of the present disclosure.

### DETAILED DESCRIPTION OF THE EMBODIMENTS

The technical solutions in the embodiments of the present disclosure will be described below clearly and completely with reference to the accompanying drawings in the embodiments of the present disclosure. Apparently, the embodiments described are merely a part rather than all of the embodiments of the present disclosure. All other embodiments obtained by a person of ordinary skill in the art based on the embodiments in the present disclosure without creative efforts shall fall within the protection scope of the present disclosure.

To make those skilled in the art better understand the solutions of the present disclosure, the present disclosure will be further described below in detail in conjunction with the accompanying drawings and specific embodiments.

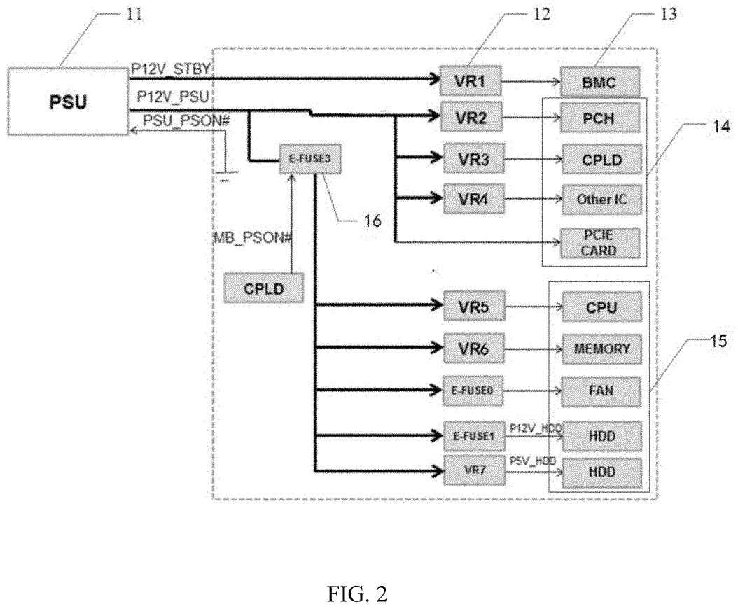

Subsequently, a power supply unit (PSU)-based power supply system provided by an embodiment of the present disclosure will be described below in detail. FIG. 2 is a structural schematic diagram of a PSU-based power supply system provided by an embodiment of the present disclosure. The system includes a PSU11, voltage converters 12, a main control component 13, load variable components 14, power-on running components 15 and a switch component 16.

A first output port of the PSU11 is connected with the main control component 13 of a main board through the voltage converter 12 and configured to supply power to the main control component 13 in a system standby state.

The PSU11 includes two output ports, respectively a P12V_STBY and a P12V_PSU.

The P12V_STBY outputs a current of 3 A, which belongs to small current output; and the P12V_PSU outputs a current of 100 A, which belongs to large current output. In the embodiment of the present disclosure, for convenience of description, an output port corresponding to the P12V_STBY may be referred to as a first output port, and an output port corresponding to the P12V_PSU may be referred to as a second output port, wherein, the first output port outputs a smaller current than the second output port.

In a system standby state, it is necessary to supply power to basic components on the main board to maintain basic functions of the main board. The basic components on the main board include a baseboard management controller (BMC) chip, a platform controller hub (PCH), a complex programmable logic device (CPLD), a functional logic chip (Other IC) and an externally inserted sub-card (PCIE CARD).

In actual application, the externally inserted sub-cards will be arranged as required; therefore, a quantity and a power consumption value of the externally inserted sub-cards are not constant; when there are a large quantity of externally inserted sub-cards or the externally inserted sub-cards have relatively large power consumption, a power supply current required will be increased; to meet the power supply requirements of each component, as shown in FIG. 2, the load variable component 14 may be directly connected with the second output port of the PSU11. In addition, an enabling end of the PSU11 is grounded to supply power to the load variable component 14 of the main board in a system standby state.

In the embodiment of the present disclosure, the main control component 13 and the load variable components 14 may be classified in various ways.

In a first way, the BMC chip may be used as the main control component 13, and the PCH chip, the CPLD chip, the functional logic chip and the externally inserted sub-card may be used as the load variable component 14 as shown in FIG. 2.

Wherein, the BMC chip is connected with the first output port of the PSU11 through a first voltage converter; the PCH chip is connected with the second output port of the PSU11 through a second voltage converter; the CPLD chip is connected with the second output port of the PSU11 through a third voltage converter; the functional logic chip is connected with the second output port of the PSU11 through a fourth voltage converter; and the externally inserted sub-card is connected with the second output port of the PSU11.

In the PSU-based power supply structure of the embodiment of the present disclosure, two power supply output groups are reserved, namely a P12V_PSU and a P12V_STBY. When the PSU is connected with an AC power cord, both the P12V_PSU and the P12V_STBY have 12V power output.

The P12V_STBY is merely used for power supply of the BMC. Since the BMC has power consumption about 7 W in normal operation, which is 0.67 A after converted into a current of the P12V_STBY, and there is only a small dynamic load change, so there is an extremely small probability of problems occurring in this power supply circuit of the P12V_STBY.

The P12V_PSU is configured to supply power to the server system and includes components with quite high power consumption, such as a central processing unit (CPU), a memory, a hard disk array and a fan. Generally, when the server system is fully equipped, the P12V_PSU has a load current as high as 100 A, which causes a quite large dynamic load change. A switch tube in a P12V_PSU conversion circuit in the PSU has a large working current. With extension of the service time, the switch tube will be aged more and more quickly, which may cause a higher probability of faults. Therefore, problems of the PSU are usually related to this conversion circuit of the P12V_PSU.

Therefore, in the power supply structure provided by the embodiment of the present disclosure, as shown in FIG. 2, the power supply circuit of the P12V_STBY is merely used for supplying power to the BMC of the main board, and the circuit of the P12V_PSU is used for supplying power to the components with quite high power consumption, such as the CPU, the memory, the hard disc array and the fan of the system, as well as other chips and circuits of the main board. In this way, when the power supply circuit of the P12V_PSU has a problem, the BMC of the main board can still work normally to monitor working state information of each functional unit and the PSU of the system.

Considering that abnormal current transmission at the second output port of the PSU will occur due to a short circuit of the voltage converter connected with the load variable component 14, so the second output port of the PSU cannot supply power to the power-on running components 15. Therefore, in order to improve the stability and reliability of the power supply system, an overcurrent protection switch 17 may be arranged between the second output port of the PSU11 and the load variable component 14.

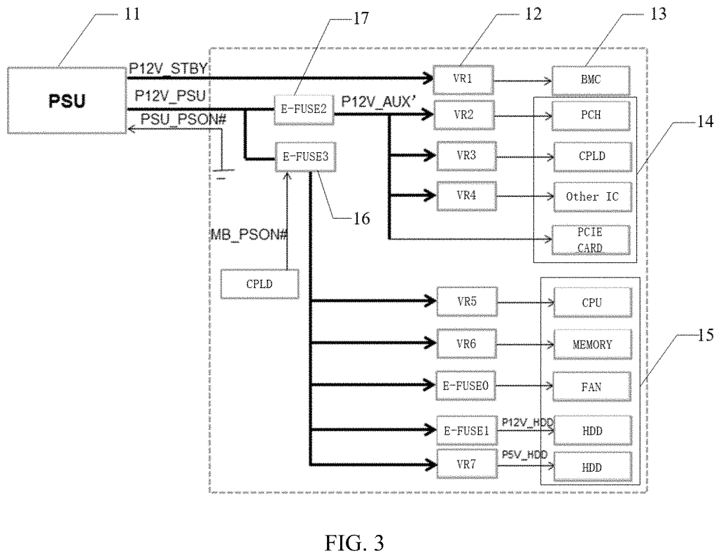

FIG. 3 is a structural schematic diagram of a power supply system provided with an overcurrent protection switch. An input end of the overcurrent protection switch 17 is connected with the second output port of the PSU11; and an output end of the overcurrent protection switch 17 is connected with input ends of the second voltage converter, the third voltage converter and the fourth voltage converter, and the externally inserted sub-card, respectively.

In a second way, the BMC chip, the PCH chip, the CPLD chip and the functional logic chip may be used as the main control components 13, and the externally inserted sub-card may be used as the load variable component 14.

Wherein, the BMC chip is connected with the first output port of the PSU11 through the first voltage converter; the PCH chip is connected with the first output port of the PSU11 through the second voltage converter; the CPLD chip is connected with the first output port of the PSU11 through the third voltage converter; the functional logic chip is connected with the first output port of the PSU11 through the fourth voltage converter; and the externally inserted sub-card is connected with the second output port of the PSU11.

To improve the stability and reliability of the power supply system, an overcurrent protection switch may be arranged between the first output port of the PSU11 and the main control component 13.

An input end of the overcurrent protection switch is connected with the first output port of the PSU11; and an output end of the overcurrent protection switch is connected with input ends of the first voltage converter, the second voltage converter, the third voltage converter and the fourth voltage converter, respectively.

The power-on running components 15 refer to components that need to be supplied with power after the system is started. To ensure that the power-on running components 15 do not consume extra power supply in a system standby state, the second output port of the PSU11 may be connected with each power-on running component 15 of the main board through the switch component 16; and the switch component 16 is in an off state in a system standby state and is in an on state after the system is started.

Wherein, each power-on running component may include a CPU, a memory, a fan, a first disk array and a second disk array.

The CPU is connected with the second output port of the PSU through a fifth voltage converter; the memory is connected with the second output port of the PSU through a sixth voltage converter; the fan is connected with the second output port of the PSU through a first overcurrent protection switch; the first disk array is connected with the second output port of the PSU through a second overcurrent protection switch; and the second disk array is connected with the second output port of the PSU through a seventh voltage converter.

In order to improve the reliability and stability of the power supply system, the switch component 16 may adopt an overcurrent protection chip in this embodiment of the present disclosure.

Considering that the CPLD chip will generate a start signal when the system is started, therefore, the start signal is generally a low level signal. In actual application, the CPLD chip may be connected with the switch component 16 in order to input a start signal to the switch component 16 after the system is started, so as to control on and off of the switch component 16.

It should be noted that, the CPLD chip inputs the start signal to the switch component 16; besides, other programmable logic chips can input the start signal to the switch component 16 as well when the system is started. For example, when the system is started, a field-programmable gate array (FPGA) chip may be used to input the start signal to the switch component 16.

It can be seen from the above technical solution that the PSU in the PSU-based power supply system includes two output ports, wherein the first output port outputs a smaller current than the second output port. The first output port of the PSU is connected with the main control components of the main board through the voltage converters in order to supply power to the main control components in a system standby state. Even if the second output port has a fault, the main control components on the main board can still normally monitor a working state of the PSU. The second output port of the PSU is connected with the load variable component of the main board, and the enabling end of the PSU is grounded to supply power to the load variable component of the main board in a system standby state. The enabling end of the PSU is grounded to ensure that both the first output port and the second output port have a voltage output when the PSU is inserted into the main board. In addition, the second output port outputs a larger current to meet the power supply requirements of the load variable component, which effectively prevents occurrence of insufficient power supply of the first output port when the load variable component has relatively high power consumption. The second output port of the PSU is connected with each power-on running component of the main board through the switch component; the switch component is in an off state in a system standby state and is in an on state after the system is started; and the PSU supplies power to each power-on running component through the second output port. By controlling on and off of the switch component, all power-on running components are ensured not to consume extra electric energy in a system standby state.

In this embodiment of the present disclosure, the overcurrent protection switch 17 may adopt a current limiting fuse. Taking a power supply system shown in FIG. 3 as an example, the load variable component 14 includes a PCH chip, a CPLD chip, a functional logic chip and an externally inserted sub-card. In this instance, a current limit value of the overcurrent protection switch may be set as 1.3 times the total load current value of the load variable component 14.

Similarly, when the main control component 13 includes a BMC chip, a PCH chip, a CPLD chip and a functional logic chip, the current limit value of the overcurrent protection switch may be set as 1.3 times the total load current value of the main control component 13.

It should be noted that the current limit value of the overcurrent protection switch, set as 1.3 times the total load current value, is proved to be a value which can achieve a better overcurrent protection effect through a large number of experiments. In actual application, a range of the current limit value of the overcurrent protection switch may be adjusted. For example, the current limit value of the overcurrent protection switch may be set at a value between 1.2 times and 1.5 times the total load current value.

By setting the current limit value of the overcurrent protection switch according to the total load current value, the overcurrent protection switch which is more in line with the overcurrent protection requirements of the power supply system can be selected, thus achieving a better overcurrent protection effect.

The load variable component 14 includes an externally inserted sub-card of which the quantity and power consumption value are not constant; to meet the power supply requirements of all components, the externally inserted sub-card is directly connected with the second output port of the PSU11 as shown in FIG. 2; besides, in this embodiment of the present disclosure, a connection way of the load variable component 14 and the PSU11 may be dynamically adjusted according to current change conditions of the externally inserted sub-card in the load variable component 14.

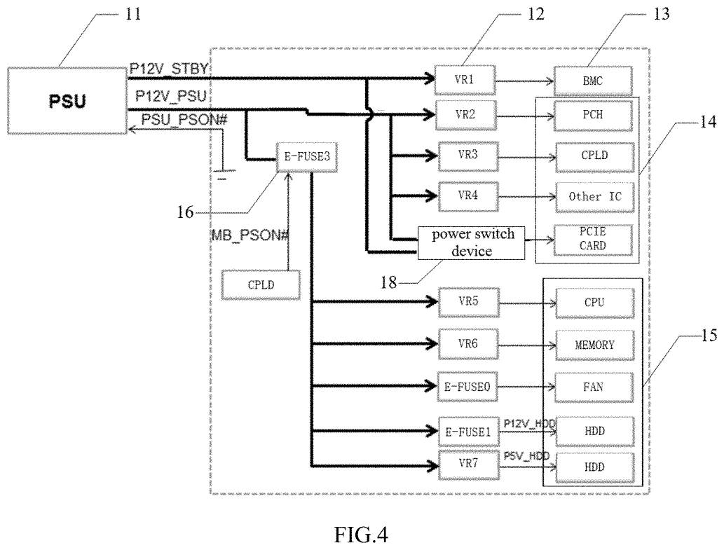

FIG. 4 is a structural schematic diagram of a PSU-based power supply system capable of dynamically adjusting a power supply way provided by an embodiment of the present disclosure. The first output port of the PSU11 is connected with main control components 13 of a main board through voltage converters 12 and configured to supply power to the main control components 13 in a system standby state.

The first output port and a second output port of the PSU11 are connected with a load variable component 14 of the main board through a power switching apparatus 18; in addition, an enabling end of the PSU11 is grounded; when the load variable component 14 has a current smaller than a threshold value, the power switching apparatus 18 is switched to supply power from the first output port of the PSU11 to the load variable component 14; when the load variable component 14 has a current larger than or equal to the threshold value, the power switching apparatus 18 is switched to supply power from the second output port of the PSU11 to the load variable component 14.

The second output port of the PSU11 is connected with each power-on running component 15 of the main board through a switch component 16; the switch component 16 is in an off state in a system standby state and is in an on state after the system is started, wherein the first output port outputs a smaller current than the second output port.

The main control components 13 and the load variable components 14 can be classified according to description in the embodiment shown in FIG. 2, which is not repeated herein.

Taking the power supply system shown in FIG. 4 as an example, to improve the stability and reliability of the power supply system, an overcurrent protection switch 17 may be arranged between the second output port of the PSU11 and the load variable component 14.

Wherein, the type and current limit value of the overcurrent protection switch 17 can refer to the description in the embodiment corresponding to FIG. 2, which is not repeated herein.

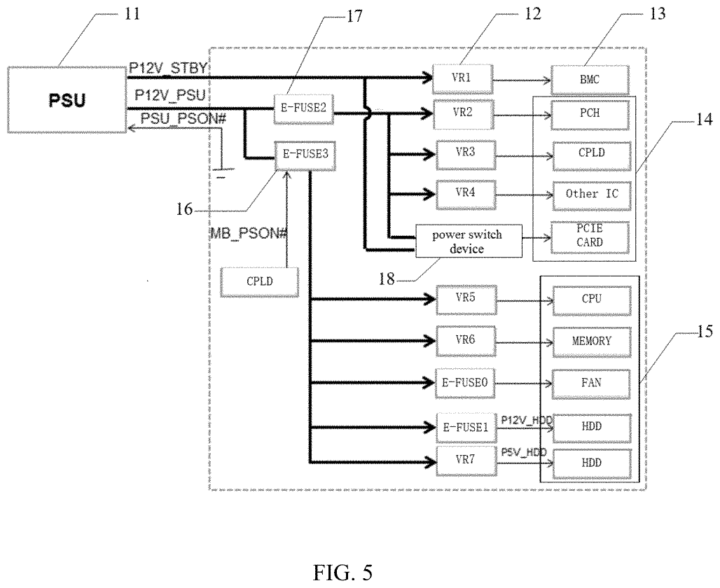

FIG. 5 is a structural schematic diagram of a power supply system provided with an overcurrent protection switch. An input end of the overcurrent protection switch 17 is connected with the second output port of the PSU11; and an output end of the overcurrent protection switch 17 is connected with input ends of the second voltage converter, the third voltage converter, the fourth voltage converter and the power switching apparatus 18, respectively.

The power consumption value of the load variable component 14 is considered as a variable factor. Therefore, in the embodiment of the present disclosure, the power switching apparatus 18 may be used to detect a current of the load variable component 14 and adjust a way of power supply from the PSU11 to the load variable component 14 according to a value of the current.

Specifically, the power switching apparatus 18 may include a power switch component and a current detection component, wherein the current detection component includes a sampling resistor and a switch control chip.

An input end of the power switching apparatus 18 is connected with the first output port and the second output port of the PSU11, respectively; and an output end of the power switching apparatus 18 is connected with the load variable component 14 through the sampling resistor.

A first input end of the switch control chip is connected with one end of the sampling resistor; a second input end of the switch control chip is connected with the other end of the sampling resistor; an output end of the switch control chip is connected with the power switch component in order to input a corresponding level signal to the power switch component according to a relationship between a current value and a threshold value of the load variable component 14, thereby controlling the power switch component to switch an output port for supplying power to the load variable component 14.

In actual application, the power switch component may include a first p-channel metal oxide semiconductor (PMOS) transistor, a second PMOS transistor, a first phase inverter and a second phase inverter.

A first port of the first PMOS transistor is connected with the second output port of the PSU11; a second port of the first PMOS transistor is connected with the load variable component 14 through the sampling resistor; a third port of the first PMOS transistor is connected with an output end of the first phase inverter; and the output end of the first phase inverter is connected with an input end of the second phase inverter.

A first port of the second PMOS transistor is connected with the first output port of the PSU11; the second port of the first PMOS transistor is connected with the load variable component 14 through the sampling resistor; and a third port of the first PMOS transistor is connected with an output end of the second phase inverter.

An output end of the switch control chip is connected with an input end of the first phase inverter and configured to input a low level to the first phase inverter when the load variable component 14 has a current smaller than the threshold value, and input a high level to the first phase inverter when the load variable component 14 has a current larger than or equal to the threshold value.

A power consumption value of the externally inserted sub-card is considered as a variable factor in the load variable component 14. Therefore, in the embodiment of the present disclosure, the power switching apparatus 18 may be used to detect a current of the externally inserted sub-card and adjust a way of power supply from the PSU11 to the load variable component 14 according to a value of the current. FIG. 4 to FIG. 6 are all schematic diagrams of direct connection between the power switching apparatus 18 and the externally inserted sub-card in the load variable component 14.

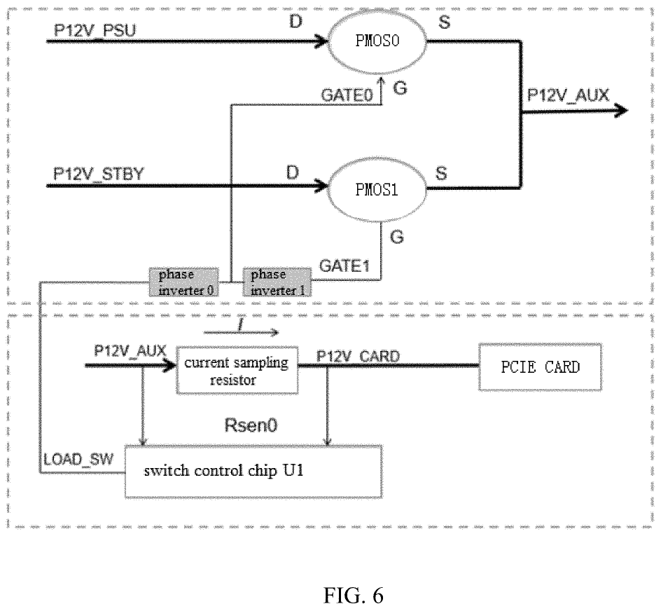

In FIG. 6, a PMOS0 is the first PMOS transistor; a PMOS1 is the second PMOS transistor; an inverter 0 is the first phase inverter; and an inverter 1 is the second phase inverter. An S end of the PMOS0 and an S end of the PMOS1 are connected with the externally inserted sub-card through current sampling resistors.

In an initial state, the PMOS1 is in an on state and the PMOS0 is in an off state, and the P12V_STBY supplies power to the PCIE CARD at the moment. After a load current I of the PCIE CARD passes through the current sampling resistor (Rsen0), a current signal will be fed back to the switch control chip U1 through a differential signal circuit.

A current threshold value I₀ is set in a circuit of the switch control chip UL If I is smaller than I₀, the switch control chip U1 will output a control signal LOAD_SW to a low level signal. If I is larger than or equal to I₀, the switch control chip U1 will output a control signal LOAD_SW as a high level signal.

When the PCIE CARD is in a light-load working state, the U1 outputs LOAD_SW as a low level signal to control the PMOS1 of the power switch component to be turned on and control the PMOS0 to be turned off. At the moment, the P12V AUX is transferred out from the P12V_STBY; and the PCIE CARD is supplied with power by the P12V_CARD through the current sampling resistor. When the PCIE CARD is in a heavy-load working state, the U1 outputs LOAD_SW as a high level signal to control the PMOS1 of a load control circuit to be turned off and the PMOS0 to be turned on; at the moment, the P12V AUX is transferred out from the P12V_PSU; and the PCIE CARD is supplied with power by the P12V_CARD through the current sampling resistor.

It can be seen from the above technical solution that the PSU in the PSU-based power supply system includes two output ports, wherein the first output port outputs a smaller current than the second output port. The first output port of the PSU is connected with the main control components of the main board through the voltage converters in order to supply power to the main control components in a system standby state. Even if the second output port has a fault, the main control components on the main board can still normally monitor a working state of the PSU. The first output port and the second output port of the PSU are connected with the load variable component of the main board through the power switching apparatus; in addition, the enabling end of the PSU is grounded so that when the load variable component has a current smaller than a threshold value, the power switching apparatus is switched to supply power from the first output port of the PSU to the load variable component; and when the load variable component has a current larger than or equal to the threshold value, the power switching apparatus is switched to supply power from the second output port of the PSU to the load variable component. The enabling end of the PSU is grounded to ensure that both the first output port and the second output port have a voltage output when the PSU is inserted into the main board. In addition, the second output port outputs a larger current to meet the power supply requirements of the load variable component, which effectively prevents occurrence of insufficient power supply of the first output port when the load variable component has higher power consumption. The second output port of the PSU is connected with each power-on running component of the main board through the switch component; the switch component is in an off state in a system standby state and is in an on state after the system is started; and the PSU supplies power to each power-on running component through the second output port. By controlling on and off of the switch component, all power-on running components are ensured not to consume extra electric energy in a system standby state.

A PSU-based power supply system provided by the embodiments of the present disclosure is described above in detail. All the embodiments in the specification are described progressively. Each embodiment focuses on description of differences with other embodiments. The same and similar parts of all the embodiments can refer to each other. Corresponding to a method disclosed by the embodiments, a device disclosed in the embodiments is described briefly, of which the correlations refer to some of the description of the method. It should be noted that a person of ordinary skill in the art can make some improvements and modifications of the present disclosure without departing from the principles of the present disclosure, and these improvements and modifications shall fall within the protection scope of the claims of the present disclosure.

Professionals can further realize that the units and algorithm steps of each example described in the embodiments disclosed herein can be realized by electronic hardware, computer software or combination of the electronic hardware and the computer software. In order to clearly explain the interchangeability of the hardware and the software, the components and steps of each example have been generally described according to functions in the above description. Whether these functions are implemented through hardware or software depends on specific applications and design constraints of the technical solutions. Professional technicians can use different methods to realize the described functions for each specific application, but such realization should not be considered to be beyond the scope of the present disclosure.

The steps of the method or algorithm described in the embodiments disclosed herein can be directly implemented by hardware, a software module executed by a processor, or combination of the hardware and the software module. The software module can be arranged in a random access memory (RAM), a memory, a read-only memory (ROM), an electrically programmable ROM, an electrically erasable programmable ROM, a register, a hard disk, a removable disk, a CD-ROM, or any other form of memory medium known in the technical field.

1. A power supply unit (PSU)-based power supply system, comprising:
a first output port of a PSU is connected with a main control component of a main board through a voltage converter in order to supply power to the main control component in a system standby state;
a second output port of the PSU is connected with a load variable component of the main board, and an enabling end of the PSU is grounded to supply power to the load variable component of the main board in a system standby state;
the second output port of the PSU is connected with each power-on running component of the main board through a switch component; the switch component is in an off state in a system standby state; after the system is started, the switch component is in an on state,
wherein the first output port outputs a smaller current than the second output port.

2. The system of claim 1, wherein the main control component comprises:
a baseboard management controller (BMC) chip, a platform controller hub (PCH) chip, a complex programmable logic device (CPLD) chip and a functional logic chip, wherein the load variable component is an externally inserted sub-card;
the BMC chip is connected with the first output port of the PSU through a first voltage converter;
the PCH chip is connected with the first output port of the PSU through a second voltage converter;
the CPLD chip is connected with the first output port of the PSU through a third voltage converter;
the functional logic chip is connected with the first output port of the PSU through a fourth voltage converter; and
the externally inserted sub-card is connected with the second output port of the PSU.

3. The system of claim 2, further comprising an overcurrent protection switch, wherein an input end of the overcurrent protection switch is connected with the first output port of the PSU; and an output end of the overcurrent protection switch is connected with input ends of the first voltage converter, the second voltage converter, the third voltage converter and the fourth voltage converter, respectively.

4. The system of claim 1, wherein the main control component is a BMC chip; the load variable component comprises a PCH chip, a CPLD chip, a functional logic chip and an externally inserted sub-card;
the BMC chip is connected with the first output port of the PSU through the first voltage converter;
the PCH chip is connected with the second output port of the PSU through the second voltage converter;
the CPLD chip is connected with the second output port of the PSU through the third voltage converter;
the functional logic chip is connected with the second output port of the PSU through the fourth voltage converter; and
the externally inserted sub-card is connected with the second output port of the PSU.

5. The system of claim 4, further comprising an overcurrent protection switch, wherein an input end of the overcurrent protection switch is connected with the second output port of the PSU; and an output end of the overcurrent protection switch is connected with input ends of the second voltage converter, the third voltage converter, the fourth voltage converter and the externally inserted sub-card, respectively.

6. The system of claim 2, wherein the CPLD chip is connected with the switch component and configured to input a start signal to the switch component after the system is started, so as to control on and off of the switch component.

7. The system of claim 4, wherein the CPLD chip is connected with the switch component and configured to input a start signal to the switch component after the system is started, so as to control on and off of the switch component.

8. The system of claim 3, wherein when the main control component comprises the BMC chip, the PCH chip, the CPLD chip and the functional logic chip, the overcurrent protection switch has a current limit value which is 1.3 times the total load current value of the main control component; and
when the load variable component comprises the PCH chip, the CPLD chip, the functional logic chip and the externally inserted sub-card, the overcurrent protection switch has a current limit value which is 1.3 times the total load current value of the load variable component.

9. The system of claim 5, wherein the main control component comprises the BMC chip, the PCH chip, the CPLD chip and the functional logic chip, the overcurrent protection switch has a current limit value which is 1.3 times the total load current value of the main control component; and
when the load variable component comprises the PCH chip, the CPLD chip, the functional logic chip and the externally inserted sub-card, the overcurrent protection switch has a current limit value which is 1.3 times the total load current value of the load variable component.

10. A PSU-based power supply system, comprising:
a first output port of a PSU is connected with a main control component of a main board through a voltage converter in order to supply power to the main control component in a system standby state;
the first output port and a second output port of the PSU are connected with a load variable component of the main board through a power switching apparatus; in addition, an enabling end of the PSU is grounded so that when the load variable component has a current smaller than a threshold value, the power switching apparatus is switched to supply power from the first output port of the PSU to the load variable component; when the load variable component has a current larger than or equal to the threshold value, the power switching apparatus is switched to supply power from the second output port of the PSU to the load variable component;
the second output port of the PSU is connected with each power-on running component of the main board through a switch component; the switch component is in an off state in a system standby state; after the system is started, the switch component is in an on state,
wherein the first output port outputs a smaller current than the second output port.

11. The system of claim 10, wherein the power switching apparatus comprises a power switch component and a current detection component, wherein the current detection component comprises a sampling resistor and a switch control chip;
an input end of the power switch component is respectively connected with the first output port and the second output port of the PSU; an output end of the power switch component is connected with the load variable component through the sampling resistor; and
a first input end of the switch control chip is connected with one end of the sampling resistor; a second input end of the switch control chip is connected with the other end of the sampling resistor; an output end of the switch control chip is connected with the power switch component in order to input a corresponding level signal to the power switch component according to a relationship between a current value and a threshold value of the load variable component, thereby controlling the power switch component to switch an output port for supplying power to the load variable component.

12. The system of claim 11, wherein the power switch component comprises a first p-channel metal oxide semiconductor (PMOS) transistor, a second PMOS transistor, a first phase inverter and a second phase inverter;
a first port of the first PMOS transistor is connected with the second output port of the PSU; a second port of the first PMOS transistor is connected with the load variable component through the sampling resistor; a third port of the first PMOS transistor is connected with an output end of the first phase inverter, and the output end of the first phase inverter is connected with an input end of the second phase inverter;
a first port of the second PMOS transistor is connected with the first output port of the PSU, and the second port of the first PMOS transistor is connected with the load variable component through the sampling resistor; a third port of the first PMOS transistor is connected with an output end of the second phase inverter; and
an output end of the switch control chip is connected with an input end of the first phase inverter and configured to input a low level to the first phase inverter when the load variable component has a current smaller than the threshold value, and input a high level to the first phase inverter when the load variable component has a current larger than or equal to the threshold value.

13. The system of claim 10, wherein the main control component comprises the BMC chip, the PCH chip, the CPLD chip and the functional logic chip; the load variable component is an externally inserted sub-card;
the BMC chip is connected with the first output port of the PSU through the first voltage converter;
the PCH chip is connected with the first output port of the PSU through the second voltage converter;
the CPLD chip is connected with the first output port of the PSU through the third voltage converter; and
the functional logic chip is connected with the first output port of the PSU through the fourth voltage converter.

14. The system of claim 13, further comprising an overcurrent protection switch, wherein an input end of the overcurrent protection switch is connected with the first output port of the PSU; and an output end of the overcurrent protection switch is connected with input ends of the first voltage converter, the second voltage converter, the third voltage converter and the fourth voltage converter, respectively.

15. The system of claim 10, wherein the main control component is the BMC chip; the load variable component comprises the PCH chip, the CPLD chip, the functional logic chip and the externally inserted sub-card;
the BMC chip is connected with the first output port of the PSU through the first voltage converter;
the PCH chip is connected with the second output port of the PSU through the second voltage converter;
the CPLD chip is connected with the second output port of the PSU through the third voltage converter;
the functional logic chip is connected with the second output port of the PSU through the fourth voltage converter; and
the externally inserted sub-card is connected with the second output port of the PSU through the power switching apparatus.

16. The system of claim 15, further comprising an overcurrent protection switch, wherein an input end of the overcurrent protection switch is connected with the second output port of the PSU; and an output end of the overcurrent protection switch is connected with input ends of the second voltage converter, the third voltage converter and the fourth voltage converter, respectively.

17. The system of claim 13, wherein the CPLD chip is connected with the switch component and configured to input a start signal to the switch component after the system is started, so as to control on and off of the switch component.

18. The system of claim 15, wherein the CPLD chip is connected with the switch component and configured to input a start signal to the switch component after the system is started, so as to control on and off of the switch component.

19. The system of claim 14, wherein when the main control component comprises the BMC chip, the PCH chip, the CPLD chip and the functional logic chip, the overcurrent protection switch has a current limit value which is 1.3 times the total load current value of the main control component; and
when the load variable component comprises the PCH chip, the CPLD chip, the functional logic chip and the externally inserted sub-card, the overcurrent protection switch has a current limit value which is 1.3 times the total load current value of the PCH chip, the CPLD chip and the functional logic chip.

20. The system of claim 16, wherein the main control component comprises the BMC chip, the PCH chip, the CPLD chip and the functional logic chip, the overcurrent protection switch has a current limit value which is 1.3 times the total load current value of the main control component; and
when the load variable component comprises the PCH chip, the CPLD chip, the functional logic chip and the externally inserted sub-card, the overcurrent protection switch has a current limit value which is 1.3 times the total load current value of the PCH chip, the CPLD chip and the functional logic chip.
